(19) United States
(12) Patent Application Publication
(10) Pub. No.: US 2012/0197977 A1
(43) Pub. Date: Aug. 2, 2012

(54) INFORMATION PROCESSING APPARATUS, INFORMATION PROCESSING METHOD, AND PROGRAM

(75) Inventors: Hideo NAGASAKA, Kanagawa (JP); Tomonori Misawa, Tokyo (JP); Tadaaki Kimijima, Tokyo (JP)

(73) Assignee: Sony Corporation, Tokyo (JP)

(21) Appl. No.: 13/339,853

(22) Filed: Dec. 29, 2011

(30) Foreign Application Priority Data
Jan. 31, 2011 (JP) 2011-017889

(51) Int. Cl. G06F 15/16

(52) U.S. Cl. 709/203

(57) ABSTRACT

An information processing apparatus includes a data processing section, the data processing section being configured to transmit device information about a peripheral device of the information processing apparatus to a server, display an app list on a display section, the app list being a list of device-specific application programs received from the server, transmit app selection information to the server in response to an input of the app selection information by a user with respect to the app list, and acquire and execute a device-specific application program identified on a basis of the app selection information from the server.

### BACKGROUND

The present disclosure relates to an information processing apparatus, an information processing method, and a program. More specifically, the present disclosure relates to an information processing apparatus, an information processing method, and a program which realize presentation or acquisition of an optimal application program according to the usage environment of an information processing apparatus such as a portable terminal used by the user.

In these days, for example, information processing apparatuses called smartphones, that is, portable terminals having the function of executing various application programs in addition to communication functions are rapidly becoming widespread.

These information terminals are configured to be able to execute application programs corresponding to various processing functions including, for example, a music player function, the function of playing back still and moving images, and other functions such as information browsing, in addition to communication functions such as phone calls and emails.

Application programs that can be executed on such portable terminals are provided with or without charge from a number of servers that are accessible from the portable terminals via communication networks such as telephone communication networks or the Internet.

These application programs are increasing day by day, which makes it difficult for the users of information terminals to gain an overall picture of what application programs are available for the information terminals of their own.

That is, while available application programs are increasing day by day, it is very difficult for the users to efficiently locate and acquire necessary or desired application programs.

For example, as search systems for content such as music and movies, various search systems have already been developed and used to date. For example, there have been used content presentation systems in which the characteristics of content already acquired by a user are analyzed, content having characteristics similar to those of the content already acquired by the user are automatically searched for on the side of a content providing server, and the content selected as a result of the search is recommended to the user.

Japanese Unexamined Patent Application Publication No. 2008-234596 discloses a system which performs edits on content acquired from a content providing server, and uploads the edited content to the server so that the content can be provided to other users. In this way, various proposals have already been made on search and distribution systems for content such as music and movies.

However, for example, in the case of application programs executed on portable terminals, even when application programs are recommended or provided solely on the basis of user's preference information as in the case of music content, such programs may not be available in some cases depending on the usage environment on the user side.

For example, while there is an application that allows a portable terminal to be used as a television remote control, unless the user has a television that can use this application, there is no use in installing this remote control app to the portable terminal.

### SUMMARY

It is desirable to provide an information processing apparatus, an information processing method, and a program which execute recommendation or presentation of an optimal application program according to the usage environment of an information terminal on the user side or the like, for example.

According to an embodiment of the present disclosure, there is provided an information processing apparatus including a data processing section, the data processing section being configured to transmit device information about a peripheral device of the information processing apparatus to a server, display an app list on a display section, the app list being a list of device-specific application programs received from the server, transmit app selection information to the server in response to an input of the app selection information by a user with respect to the app list, and acquire and execute a device-specific application program identified on a basis of the app selection information from the server.

Further, in the information processing apparatus according to an embodiment of the present disclosure, as the app list, the data processing section displays, on the display section, a list that associates a device name of the peripheral device with information about an available application corresponding to the peripheral device identified by the device name.

Further, in the information processing apparatus according to an embodiment of the present disclosure, the information processing apparatus further includes a device discovery section that executes device discovery according to a Universal Plug and Play (UPnP) protocol, and the data processing section transmits the device information about the peripheral device acquired by the device discovery section to the server.

Further, in the information processing apparatus according to an embodiment of the present disclosure, the information processing apparatus further includes a QR code reader that executes reading of a QR code, and the data processing section transmits the device information about the peripheral device acquired by the QR code reader to the server.

Further, in the information processing apparatus according to an embodiment of the present disclosure, the data processing section transmits the device information about the peripheral device based on a user input made via an input section to the server.

Further, according to an embodiment of the present disclosure, there is provided an information processing apparatus including a data processing section, the data processing section being configured to transmit content identification information to a server, display an app list on a display section, the app list being a list of content-specific application programs received from the server, transmit app selection information to the server in response to an input of the app selection information by a user with respect to the app list, and acquire and execute a content-specific application program identified on a basis of the app selection information from the server.

Further, in the information processing apparatus according to an embodiment of the present disclosure, as the app list, the data processing section displays, on the display section, a list that associates a title of content with application information related to the content.

Further, in the information processing apparatus according to an embodiment of the present disclosure, the app list displayed on the display section is a list of available applications linked to content played back by using a television or a recording/playback device as a peripheral device.

Further, in the information processing apparatus according to an embodiment of the present disclosure, the data processing section outputs identification information indicating presence or absence of a content-specific application that can be acquired from the server within a content list displayed on the display section during execution of a remote control application corresponding to a television or a recording/playback device as a peripheral device.

Further, according to an embodiment of the present disclosure, there is provided an information processing method which is executed in an information processing apparatus, including a data processing section transmitting device information about a peripheral device of the information processing apparatus to a server, displaying an app list on a display section, the app list being a list of device-specific application programs received from the server, transmitting app selection information to the server in response to an input of the app selection information by a user with respect to the app list, and acquiring and executing a device-specific application program identified on a basis of the app selection information from the server.

Further, according to an embodiment of the present disclosure, there is provided an information processing method which is executed in an information processing apparatus, including a data processing section transmitting content identification information to a server, displaying an app list on a display section, the app list being a list of content-specific application programs received from the server, transmitting app selection information to the server in response to an input of the app selection information by a user with respect to the app list, and acquiring and executing a content-specific application program identified on a basis of the app selection information from the server.

Further, according to an embodiment of the present disclosure, there is provided a program for causing information processing to be executed in an information processing apparatus, the program including causing a data processing section to transmit device information about a peripheral device of the information processing apparatus to a server, display an app list on a display section, the app list being a list of device-specific application programs received from the server, transmit app selection information to the server in response to an input of the app selection information by a user with respect to the app list, and acquire and execute a device-specific application program identified on a basis of the app selection information from the server.

Further, according to an embodiment of the present disclosure, there is provided a program for causing information processing to be executed in an information processing apparatus, the program including causing a data processing section to transmit content identification information to a server, display an app list on a display section, the app list being a list of content-specific application programs received from the server, transmit app selection information to the server in response to an input of the app selection information by a user with respect to the app list, and acquire and execute a content-specific application program identified on a basis of the app selection information from the server.

The program according to an embodiment of the present disclosure is, for example, a program that is provided via a storage medium to an information processing apparatus or computer system capable of executing various program codes. By executing such a program in a program executing section on the information processing apparatus or computer system, processes according to the program are implemented.

Other objects, features, and advantages of the present disclosure will become apparent from the following detailed description of embodiments of the present disclosure and the accompanying drawings. The term system as used in this specification refers to a logical aggregation of a plurality of devices, and is not limited to one in which the constituent devices exist within the same casing.

According to an embodiment of the present disclosure, a configuration that enables efficient retrieval and use of applications is realized. For example, device information about each peripheral device such as a television located in the periphery of a user's information processing apparatus is acquired and transmitted to a server, a list of device-specific applications acquired from the server is displayed, and a device-specific application is acquired from the server in accordance with user's selection information. Further, a content identifier for a TV program or the like is transmitted to a server, a list of content-specific applications acquired from the server is displayed, and a content-specific application is acquired from the server in accordance with user's selection information. Through these processes, it is possible to efficiently search for and acquire an optimal app according to the user's usage environment.

### BRIEF DESCRIPTION OF THE DRAWINGS

FIG. 1 is a diagram illustrating an example of the configuration and processing overview of an information processing apparatus according to an embodiment of the present disclosure;

FIG. 2 is a diagram illustrating the sequence of acquisition of applications corresponding to each peripheral device;

FIG. 3 is a diagram illustrating an example of display of a device-specific application list;

FIG. 4 is a diagram illustrating the sequence of acquisition of applications linked to content;

FIG. 5 is a diagram illustrating an example of use of a television remote control application;

FIG. 6 is a diagram illustrating an example of data displayed on a display section of an information processing apparatus by user's selection of a program;

FIG. 7 is a diagram illustrating an example of display of a program-specific application list;

FIG. 8 is a diagram illustrating an example of display of application presence/absence information;

FIG. 9 is a diagram illustrating an example of display of an application list in a case where an optimal application differs with the progress of a program;

FIG. 10 is a diagram illustrating an example of display of an application list in a case where an optimal application differs with the progress of a program;

FIG. 11 is a diagram illustrating an example of display of an application list when playing back a program already recorded on an information recording apparatus such as a BD recorder;

FIG. 12 is a diagram illustrating an example of display of an application list in a state in which a game is being executed in accordance with a game program; and

FIG. 13 is a diagram illustrating an example of the hardware configuration of each of an information processing apparatus and a server.

### DETAILED DESCRIPTION OF EMBODIMENTS

Hereinbelow, an information processing apparatus, an information processing method, and a program according to an embodiment of the present disclosure are described in detail with reference to the drawings. The description is given in the following order of topics.

1. Configuration and processing overview of an information processing apparatus

2. Example of acquisition of applications corresponding to each peripheral device

3. Example of acquisition of applications linked to content

4. Other embodiments

4-1. Example of displaying application presence/absence information on a peripheral device

4-2. Example of provision of an application list and applications according to the progress of a program

4-3. Example of provision of applications in playback of various kinds of content

4-4. Installation of an application to a peripheral device

5. Example of the hardware configuration of each of an information processing apparatus and a server

### 1. Configuration and Processing Overview of an Information Processing Apparatus

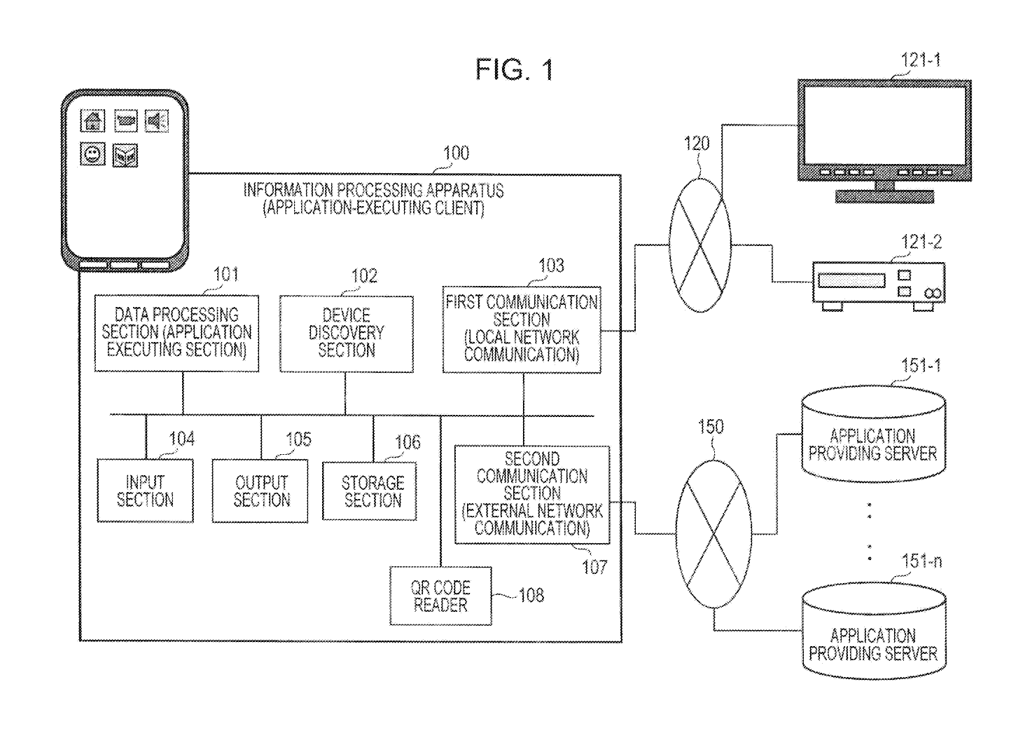

First, the configuration and processing overview of an information processing apparatus according to an embodiment of the present disclosure is described with reference to FIG. 1 onward.

Referring to FIG. 1, an example of the configuration and processing of an information processing apparatus according to an embodiment of the present disclosure is described.

FIG. 1 shows an example of the configuration of an information processing apparatus 100 according to an embodiment of the present disclosure. The information processing apparatus 100 is, for example, a portable information terminal such as a smartphone having, for example, communication functions such as telephone calls and emails, and the function of executing various application programs.

It should be noted that in the following description of embodiments, “application program” is abbreviated as “application” or “app” in some cases.

FIG. 1 further shows each of a peripheral device (television) 121-1 and a peripheral device (BD recorder) 121-2, as a peripheral device 121 connected to a local network 120 such as a home network.

Further, FIG. 1 shows application providing servers 151-1 to 151-n connected to an external network 150 such as a telephone communication network or the Internet.

The local network 120 is, for example, a home network that complies with the Digital Living Network Alliance (DLNA). The local network 120 is a home network capable of two-way communication using, for example, Universal Plug and Play (UPnP) as the protocol.

As shown in FIG. 1, the information processing apparatus 100 has a data processing section 101, a device discovery section 102, a first communication section 103, an input section 104, an output section 105, a storage section 106, a second communication section 107, and a QR code reader 108.

The data processing section 101 executes various kinds of data processing executed on the information processing apparatus 100. Specifically, for example, the data processing section 101 performs processing such as execution of applications acquired from the external application providing servers 151-1 to 151-n. The data processing section 101 has a CPU having a program execution function or the like.

The data processing section 101 executes processing including, for example, transmitting device information about each peripheral device of the information processing apparatus 100 or content information to a server, displaying a device-specific app list or a content-specific app list received from the server on a display section, transmitting app selection information to the server in response to an input of app selection information by the user with respect to the app list, and acquiring and executing an application program identified on the basis of the selection information. Details of such processing are described later.

For example, the device discovery section 102 acquires device information from each peripheral device with which communication can be made via a local network such as a home network. For example, the device discovery section 102 executes a device discovery sequence according to UPnP, and executes processing such as discovery of networked devices and acquisition of device information from the devices.

An overview of the device discovery sequence according to UPnP is briefly described. For example, device discovery is executed in accordance with the following processing sequence.

First, a device discovery message is transmitted by multicasting via the first communication section 103 of the information processing apparatus 100.

Each of the peripheral devices 121-1 to 121-n receives the device discovery message from the information processing apparatus 100, and transmits to the information processing apparatus 100 a response indicating that the corresponding peripheral device is a networked device.

After receiving the response from each of the peripheral devices 121-1 to 121-n, the information processing apparatus 100 executes requesting each of the peripheral devices 121-1 to 121-n for device description.

In response to the receipt of the device description request from the information processing apparatus 100, each of the peripheral devices 121-1 to 121-n transmits a message recording a description about the device (device information (device description message)) to the information processing apparatus 100.

The information processing apparatus 100 stores the device information acquired from each of the peripheral devices 121-1 to 121-n into the storage section 106.

The device information (device description message) represents a message disclosing device information. The device information is, for example, information containing a device name (friendly name), a unique device name (UDN) as a device identifier, icon information, and so on.

The device discovery section 102 of the information processing apparatus 100 acquires device information about each of the peripheral devices 121-1 to 121-n in accordance with the above-mentioned sequence, for example. By transmitting the acquired information to the application providing server 151, it is possible to acquire an optimal application according to each peripheral device. This processing is described later in detail.

The first communication section 103 executes communication with each of the peripheral devices 121-1 to 121-n via the local network 120. As described previously, the local network 120 is, for example, a home network that complies with the Digital Living Network Alliance (DLNA).

The input section 104 is an input section including an input section for making an input of operation information by the user, or the like, and an input section for making an input of data from an external device.

The output section 105 is an output section including a display section, an audio information output section, and a data output section for an external device.

The storage section 106 is a storage section configured by, for example, a flash memory, a hard disk, a RAM, or a ROM.

The second communication section 107 is, for example, a communication section that executes communication via the external network 150 such as a telephone communication network or the Internet. For example, the second communication section 107 executes communication with the application providing servers 151-1 to 151-n connected to the external network 150.

The QR code reader 108 is applied to, for example, reading of a QR code indicating device information which is recorded in each of the peripheral devices 121-1 to 121-n.

### 2. Example of Acquisition of Applications Corresponding to Each Peripheral Device

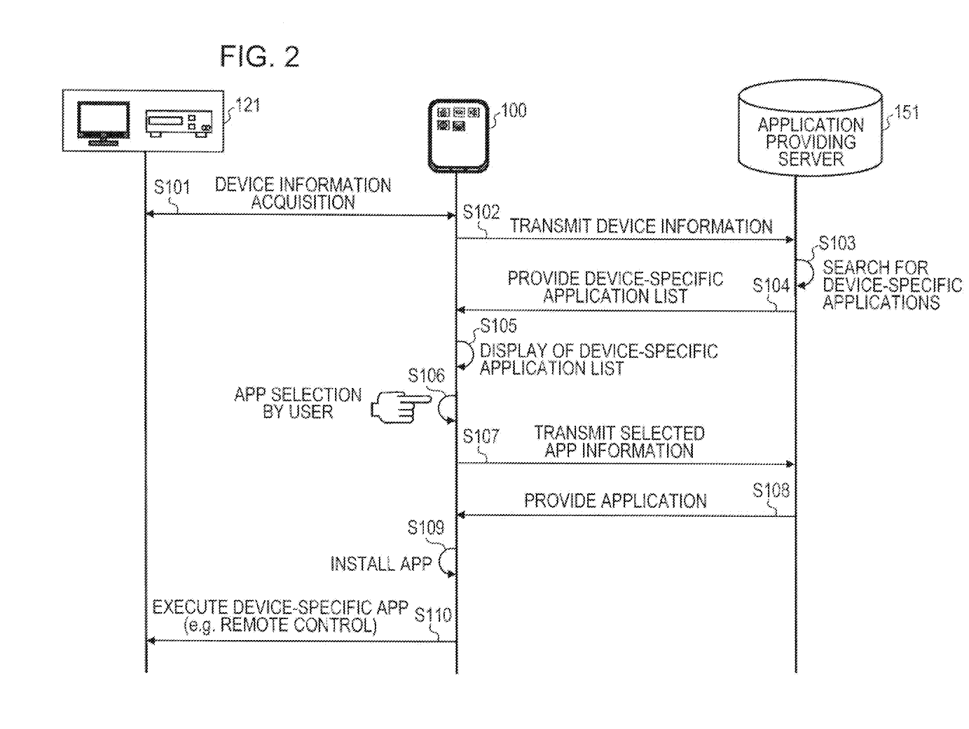

Next, an example of processing executed by the information processing apparatus 100 according to an embodiment of the present disclosure is described with reference to a sequence diagram shown in FIG. 2.

FIG. 2 is a sequence diagram illustrating a process in which the information processing apparatus 100 executes device discovery for the peripheral device 121 connected to the local network 120 to which the information processing 100 belongs, acquires device information about the discovered device, provides the acquired device information to the application providing server 151 connected to the external server 150, and acquires applications corresponding to each peripheral device.

The information processing apparatus 100 executes device information acquisition in step S101. For example, as described previously, the information processing apparatus 100 executes a device discovery sequence according to UPnP, and executes device discovery for the peripheral devices 121-1 to 121-n connected to the network, and acquisition of device information from the devices.

It should be noted that the acquisition of device information may be performed not only by this device discovery according to UPnP but also by, for example, reading a QR code printed on the casing of each of the peripheral devices 121-1 to 121-n, or on an attached document or the like with the QR coder reader 108.

Alternatively, the user may input device information about each of the peripheral devices 121-1 to 121-n via the input section 104.

Next, in step S102, the information processing apparatus 100 transmits the device information about each of the peripheral devices 121-1 to 121-n to the application providing server 151.

In step S103, on the basis of the device information received from the information processing apparatus 100, the application providing server 151 searches for applications that are available for each of the devices identified in accordance with the device information.

For example, if the peripheral device 121 is a television, as an example of applications available for the television, there is an application that provides a remote control function corresponding to a television which can be used for switching television channels or the like.

Also, for example, if the peripheral device 121 is a BD recorder, as an example of applications available for the BD recorder, there is an application that provides a remote control function corresponding to a BD recorder which can be used for scheduled recording or the like.

The application providing server 151 has data including information associating a device identifier corresponding to the peripheral device 121 with applications available for each corresponding device. In step S103, the application providing server 151 executes a search based on each device identifier included in the device information received from the information processing apparatus 100, and extracts device-specific application programs.

In step S104, the application providing server 151 selects the device-specific applications acquired as a result of the search, that is, applications available for the respective peripheral devices 121-1 to 121-n of the information processing apparatus 100, creates a list of the selected applications, and provides the list to the information processing apparatus 100.

Next, in step S105, the information processing apparatus 100 displays the peripheral device-specific application list received from the application providing server 151 to the output section (display section) 105 of the information processing apparatus 100.

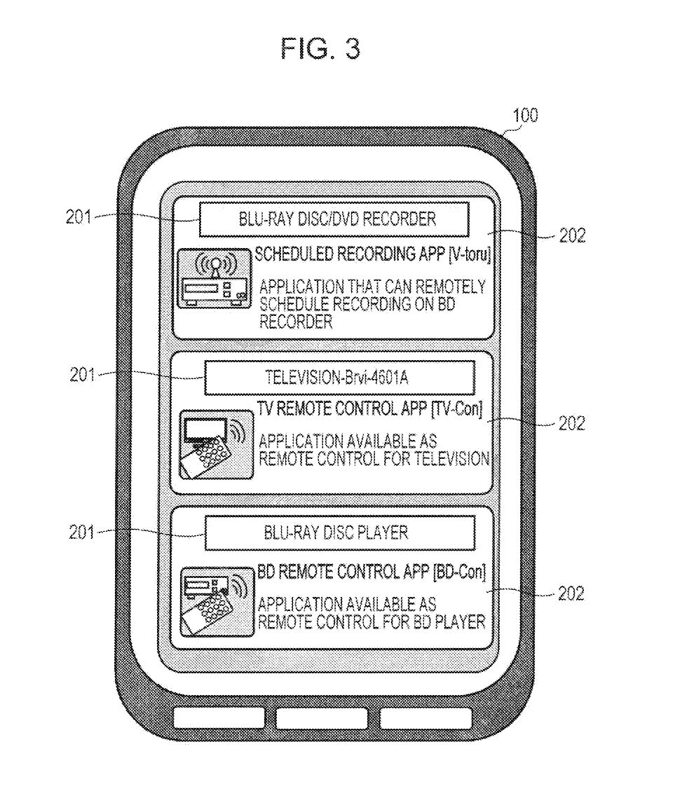

An example of display of this application list is shown in FIG. 3.

As shown in FIG. 3, the application list is a list including information associating a device name 201 with application information 202.

The device name 201 is a device name indicating a device discovered by device discovery.

The application information 202 is description information about an application available for the device indicated by the device name 201.

FIG. 3 shows an example of display of a list including the following three pieces of application information.

(1) Device name: Blu-ray disc/DVD recorder

Application information: Scheduled recording app [V-toru] Application that can remotely schedule recording on BD recorder

(2) Device name: Televesion-Brvi-4601A

Application information: TV remote control app [TV-Con] Application available as remote control for television

(3) Device name: Blu-ray disc player Application information: BD remote control app [BD-Con]

Application available as remote control for BD player

The device-specific application list displayed on the information processing apparatus 100 in step S105 shown in FIG. 2 is, for example, the list as shown in FIG. 3.

As shown in FIG. 3, on the output section 105 (=display section) of the information processing apparatus 100, applications available for the respective peripheral devices 121-1 to 121-n are displayed on a device-by-device basis.

Accordingly, the user is able to easily select a desired application from among applications corresponding to the devices owned by the user.

For example, in step S106, the user selects the remote control app corresponding to a television from the list displayed on the information processing apparatus 100.

In step S107, the information processing apparatus 100 transmits application selection information to the application providing server 151, via the second communication section 107 and the external network 150 shown in FIG. 1.

For example, when the user designates an icon within the application information 202 shown in FIG. 3, application identification information such as an URL associated with the icon is transmitted to the application providing server 151.

In step S108, the application providing server 151 provides an application program corresponding to the selected app information received from the information processing apparatus 100 to the information processing apparatus 100.

In step S109, the information processing apparatus 100 installs the application program received (downloaded) from the application providing server 151 into the information processing apparatus 100. That is, the information processing apparatus 100 stores the application program into the storage section 106, and make settings or the like for executing the stored application program.

Next, in step S110, the information processing apparatus 100 starts and executes the installed application program.

For example, if the installed application program is a remote control app that is available for a television as the peripheral device 121, by executing the remote control app, it is possible to execute switching ON/OFF of the television, channel switching, volume settings, and the like.

Also, for example, if the installed application program is a remote control app that is available for a BD recorder as the peripheral device 121, by executing the remote control app, it is possible to execute processing such as scheduling of a program for recording or playback of already-recorded data on the BD recorder.

### 3. Example of Acquisition of Applications Linked to Content

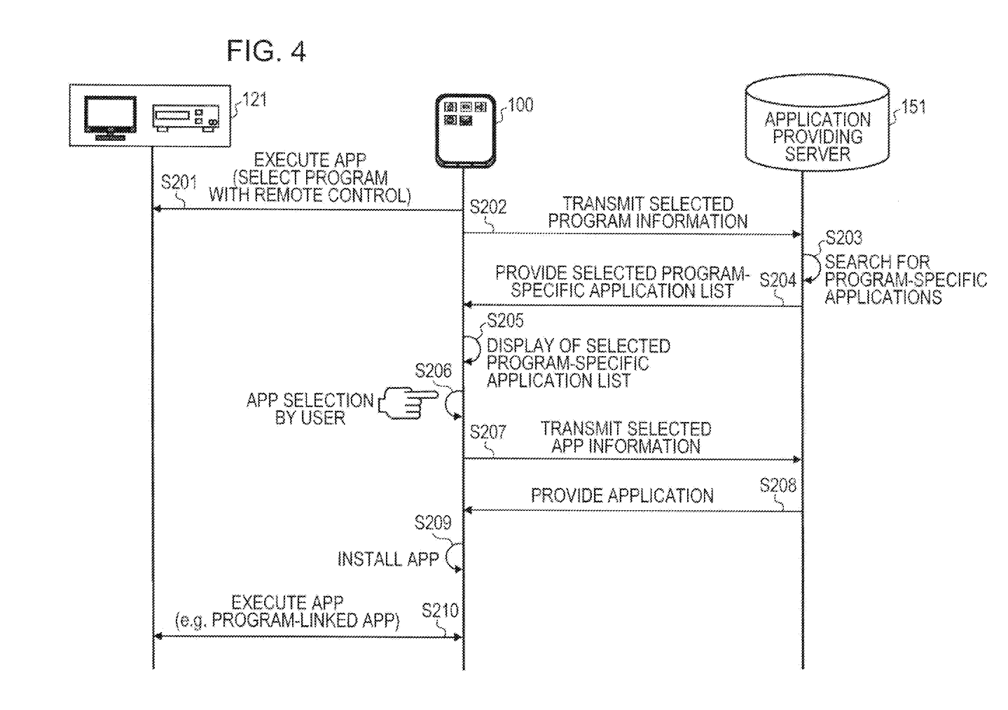

Next, an example of acquisition of applications linked to content executed by the information processing apparatus 100 according to an embodiment of the present disclosure is described with reference to a sequence diagram shown in FIG. 4.

FIG. 4 illustrates processing performed while the information processing apparatus 100 is executing an application acquired in the application acquisition described previously with reference to the sequence diagram shown in FIG. 2, for example, a television remote control app.

The user of the information processing apparatus 100 executes the television remote control application installed in the information processing apparatus 100, operates a television as the peripheral device 121, and views a given program (content) by switching channels, for example.

The information processing apparatus 100 transmits this program information (content information) to the application providing server 151.

The application providing server 151 generates a list of program (content)-linked application programs on the basis of the program information (content) received from the information processing apparatus 100, and provides the list to the information processing apparatus 100.

Through this processing, the user is able to acquire and execute applications related to the program being currently viewed, and enjoy the applications together with the program.

Processing in each of steps in the sequence diagram shown in FIG. 4 is described sequentially.

In step S201, the user of the information processing apparatus 100 executes a television remote control application already installed in the information processing apparatus 100, makes channel settings on a television as the peripheral device 121, and selects and views a predetermined program (content).

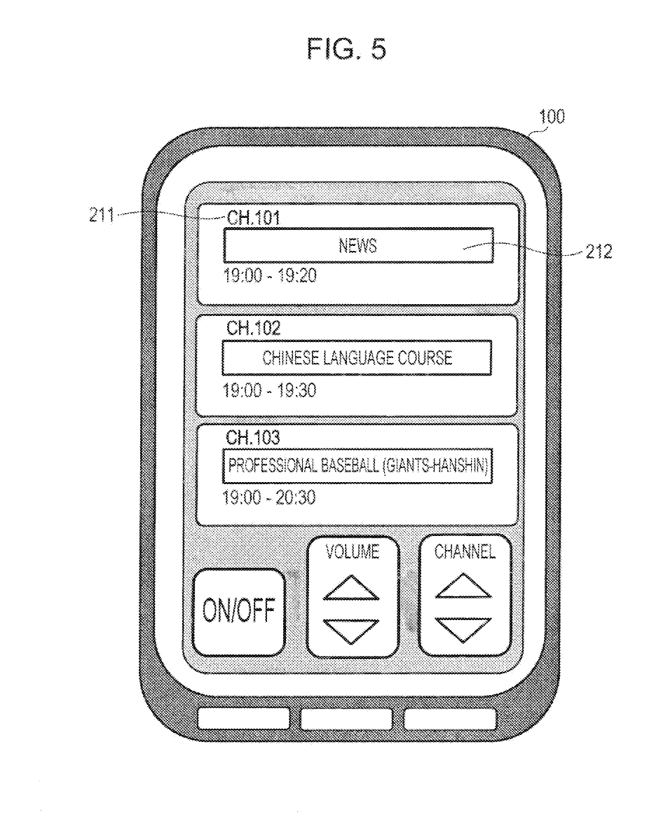

While the television remote control application is being executed, on the display section as the output section 105 of the information processing apparatus 100, for example, program information for each channel, and operating sections for television switch ON/OFF, volume settings, and channel settings as shown in FIG. 5 are displayed.

A program list including a channel 211 and a program title 212 shown in FIG. 5 is, for example, information acquired by the information processing apparatus 100 from an application providing server or another program-information providing server by executing the television remote control application.

The user selects a program to view from this program list. For example, the user selects a program by touching the presentation screen of the list on the information processing apparatus 100. This operation information is inputted to the television as the peripheral device 121 via the first communication section 103, and television channels are switched. The input of operation information to the television may be performed by, for example, using functions such as infrared communication or other radio communication.

Further, in step S202, information about the user's program-selecting operation, that is, program information (content information) selected as a program to view, is also transmitted to the application providing server 151 via the second communication section 107.

For example, suppose that the program selected by the user is “Chinese language course” in the middle of the program list shown in FIG. 5.

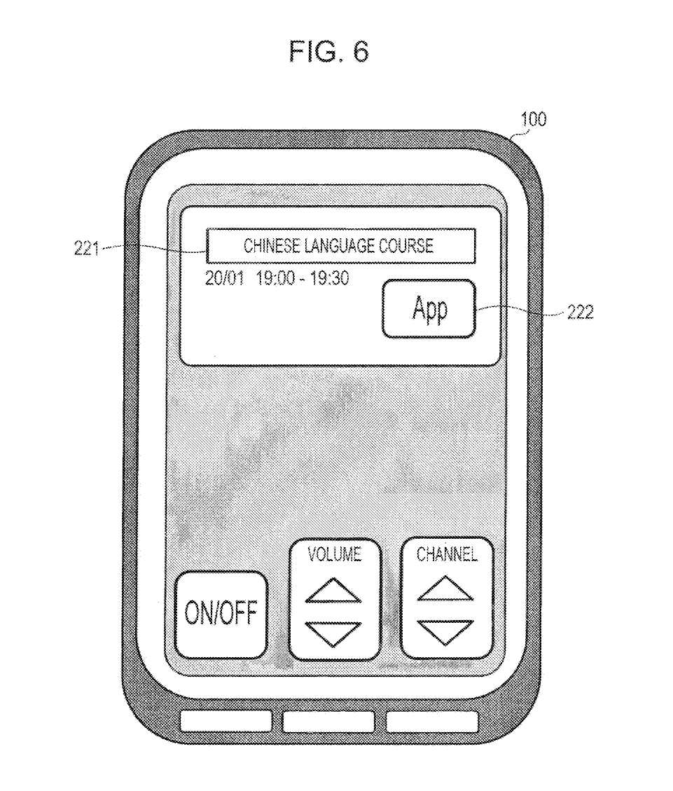

With this program selection by the user, display on the display section of the information processing apparatus 100 is switched to, for example, the display as shown in FIG. 6.

The program title 221 selected by the user, and application presence/absence information 222 indicating whether or not the server holds applications corresponding to the program are displayed.

When [App] is displayed as the application presence/absence information 222, this indicates that application programs linked or related to the program (content) can be acquired from the application providing server 151.

In step S203, the application providing server 151 searches for program-specific applications on the basis of the program information (content information) received from the information processing apparatus 100.

For example, suppose that the program selected by the user is “Chinese language course” in the middle of the program list shown in FIG. 5.

The application providing server 151 searches for application programs linked or related to the program “Chinese language course” in step S203.

The application providing server 151 has, for example, data including information associating program (content) identifiers and related applications with each other. In step S203, the application providing server 151 executes a search based on a program identifier.

In step S204, the application providing server 151 selects program-specific applications acquired as a result of the search, creates a list of the selected applications, and provides the list to the information processing apparatus 100.

Next, in step S205, the information processing apparatus 100 displays the program-specific application list received from the application providing server 151 to the output section (display section) 105 of the information processing apparatus 100.

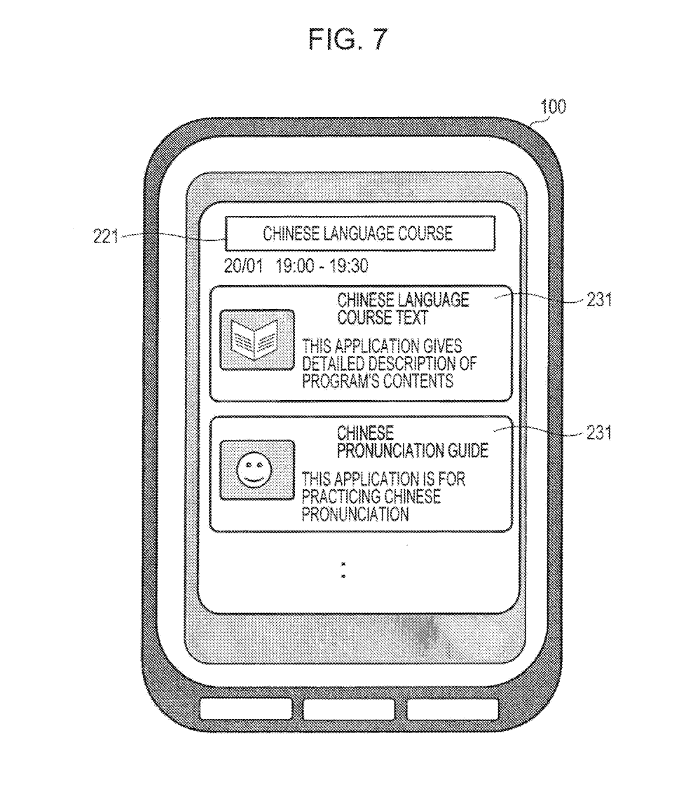

An example of display of this application list is shown in FIG. 7.

As shown in FIG. 7, the application list is a list including information associating the program title 221 (=content title) selected by the user as a program to view, with the application information 231.

The program title (content title) 221 indicates a program selected by the user as a program to view by using a television remote control application.

The application information 231 is description information about an available application linked to the program corresponding to the program title 221, or an application related to the program.

FIG. 7 shows an example in which the program (content) selected by the user is [Chinese language course], and a list including the following two pieces of application information related to this program (content): [Chinese language course] is displayed.

(1) Chinese language course text: Program-linked application that gives detailed description of program's contents

(2) Chinese pronunciation guide: Application for practicing Chinese pronunciation

The program-specific application list displayed on the information processing apparatus 100 in step S205 shown in FIG. 4 is, for example, a list as shown in FIG. 7.

As shown in FIG. 7, on the information processing apparatus 100, information about available applications linked to a program or related applications is displayed.

Accordingly, the user is able to easily select a desired application from among applications corresponding to the program (content) being viewed by the user.

In step S206, the user selects a given application from the list displayed on the information processing apparatus 100.

In step S207, the information processing apparatus 100 transmits application selection information to the application providing server 151, via the second communication section 107 and the external network 150 shown in FIG. 1.

For example, upon designating an icon within the application information 231 shown in FIG. 7, application identification information such as an URL associated with the icon is transmitted to the application providing server 151.

In step S208, the application providing server 151 provides an application program corresponding to the selected app information received from the information processing apparatus 100 to the information processing apparatus 100.

In step S209, the information processing apparatus 100 installs the application program received (downloaded) from the application providing server 151 into the information processing apparatus 100. That is, the information processing apparatus 100 stores the application program into the storage section 106, and make settings or the like for executing the stored application program.

Next, in step S210, the information processing apparatus 100 starts and executes the installed application program.

For example, if the installed application program is an application that displays detailed text information or the like in a manner linked to the program “Chinese language course” being viewed on the television, it is possible to execute such processing as outputting timely detailed text information as display data on the information processing apparatus, in accordance with the progress of the program.

Such program-linked information provision can be executed by, for example, processing such as continuously executing communication between the information processing apparatus 100 and the application providing server 151, and sequentially providing information synchronized to the progress of the program to the information processing apparatus 100 from the application providing server.

Alternatively, such program-linked information provision can be implemented also by processing such as displaying information matched to the program's contents in synchronization with the elapsed broadcast time or playback time of the program, on the display section of the information processing apparatus in accordance with a clock inside the information processing apparatus.

In the case of executing either type of processing, the processing sequence is defined in an application program provided from the server, and the processing is executed in accordance with this application.

### 4. Other Embodiments

Next, other embodiments such as modifications of the above-described embodiments is described.

### (4-1. Example of Displaying Application Presence/Absence Information on a Peripheral Device)

The embodiment previously described with reference to FIG. 6 is configured to display, on the display section of the information processing apparatus 100, the application presence/absence information 222 indicating whether or not there are applications that can be provided from a server corresponding to a program selected by the user as a program to view by using a television remote control app.

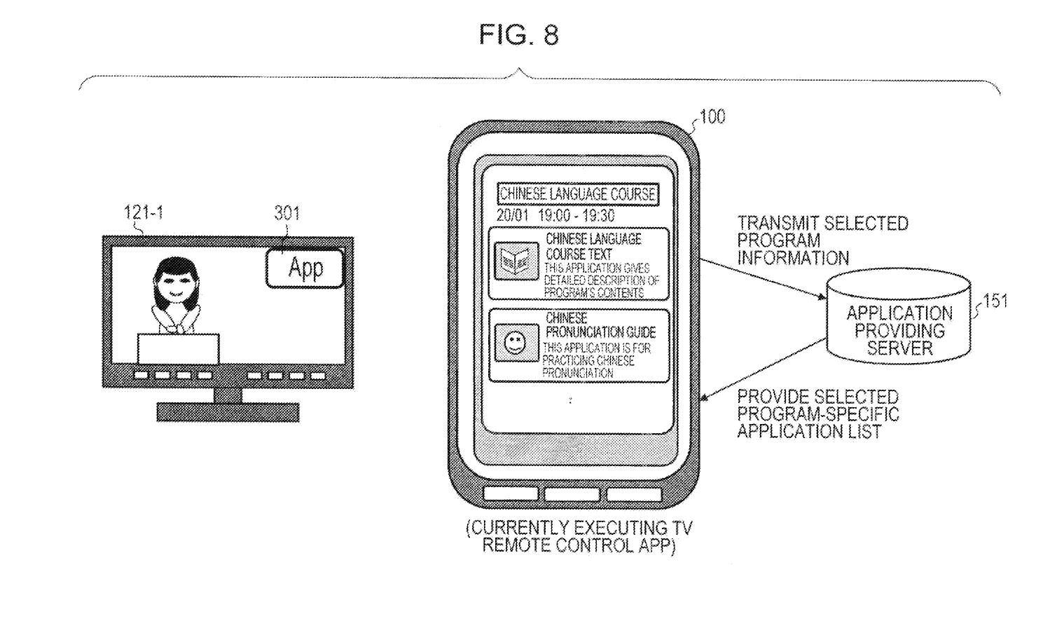

This application presence/absence information may be configured to be displayed, for example, on the screen of the television being viewed by the user as shown in FIG. 8. Application presence/absence information 301 shown in FIG. 8 represents such application presence/absence information.

It should be noted that control of display of the application presence/absence information 301 is executed in accordance with, for example, a television remote control application program in the information processing apparatus 100. For example, the information processing apparatus 100 outputs a display command for the application presence/absence information 301 to the television as a peripheral device via the local network 120 shown in FIG. 1, thereby displaying the application presence/absence information 301.

In this setting as well, the information processing apparatus 100 transmits program information to the application providing server 151.

The application providing server 151 generates a list of program-related applications on the basis of the program information received from the information processing apparatus 100, and provides the list to the information processing apparatus 100.

The information processing apparatus 100 displays the application list received from the application providing server 151.

That is, the processing according to the sequence described above with reference to FIG. 4 is executed.

### (4-2. Example of Provision of an Application List and Applications According to the Progress of a Program)

The embodiment previously described is configured so that the application providing server sets an application list corresponding to a program selected by the user as a program to view, and provides the application list to the information processing apparatus 100.

However, if there are many applications corresponding to the program, an optimal application may differ with the progress of the program. In the case where an optimal application differs with the progress of the program in this way, the user is notified of an optimal application according to the progress of the program among applications in the application list.

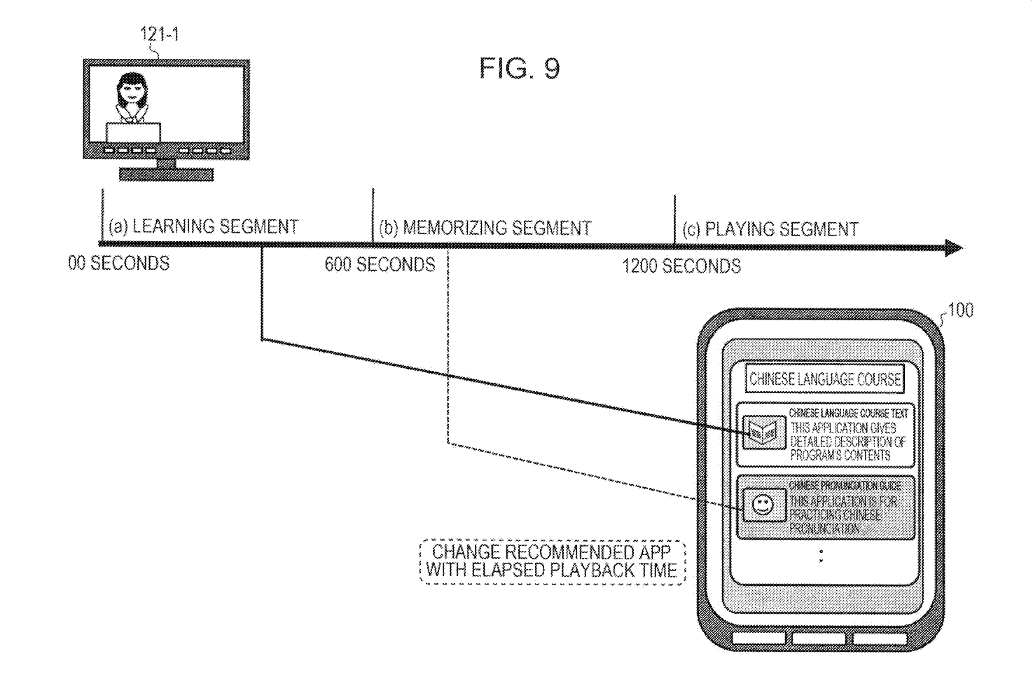

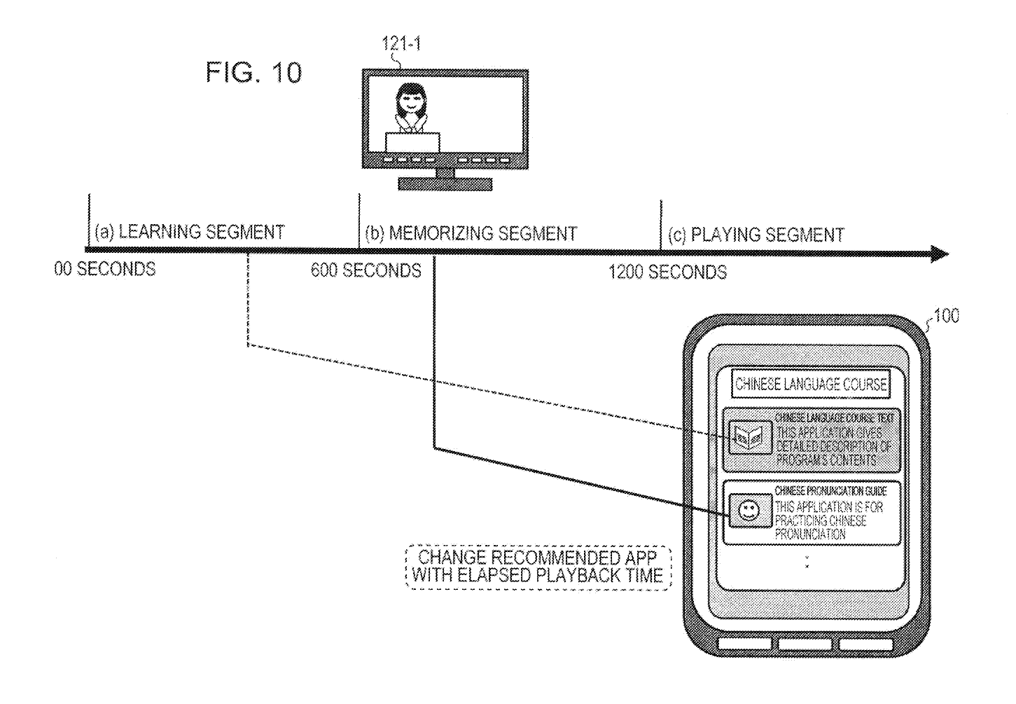

This processing example is described with reference to FIGS. 9 and 10.

For example, suppose that the user is viewing “Chinese language course” by executing a TV remote control app.

As shown in FIGS. 9 and 10, this program has the following three-part structure.

(a) Learning segment

(b) Memorizing segment

(c) Playing segment

First, as shown in FIG. 9, during playback of (a) Learning segment on the television, when displaying an application list on the information processing apparatus 100, the application list is displayed in such a way that an optimal application for the contents of (a) Learning segment can be identified. For example, the optimal application is highlighted or emphasized. In the example shown in FIG. 9, only the application information related to “Chinese language course text” within the application list displayed on the information processing apparatus 100 is emphasized as an optimal application for the contents of (a) Learning segment.

As the program further proceeds, during playback of (b)

Memorizing segment on the television, as shown in FIG. 10, when displaying an application list on the information processing apparatus 100, the application list is displayed in such a way that an optimal application for the contents of (b) Memorizing segment can be identified. For example, the optimal application is highlighted or emphasized. In the example shown in FIG. 10, only the application information related to “Chinese pronunciation guide” within the application list displayed on the information processing apparatus 100 is emphasized as an optimal application for the contents of (b) Memorizing segment.

The synchronization between the elapsed playback time of each segment of the program on the television, and the change of display on the information processing apparatus 100 can be executed in a manner similar to the aforementioned processing example. That is, the synchronization can be executed by, for example, processing such as continuously executing communication between the information processing apparatus 100 and the application providing server 151, and sequentially providing information synchronized to the progress of the program to the information processing apparatus 100 from the application providing server.

Alternatively, the synchronization can be implemented also by processing such as displaying information matched to the program's contents in synchronization with the elapsed broadcast time or playback time of the program, on the display section of the information processing apparatus in accordance with a clock inside the information processing apparatus.

In the case of executing either type of processing, the processing sequence is defined in an application program provided from the server, and the processing is executed in accordance with this application.

Such processing can be used not only while viewing a program broadcast on the television but also while, for example, playing back a program already recorded on an information recording apparatus such as a BD recorder.

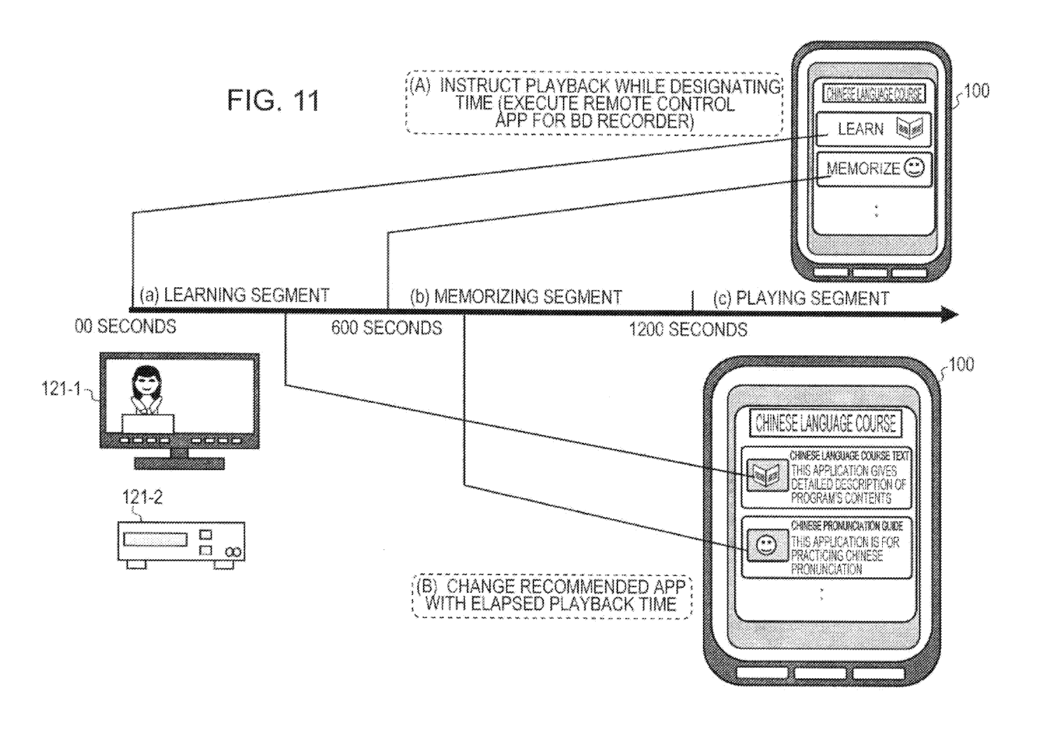

In the example shown in FIG. 11, first, as shown in FIG. 11(A), the information processing apparatus 100 executes a remote control app for the BD recorder.

This BD remote control app is configured to enable a specific segment to be designated for playback on a segment-by-segment basis from already-recorded content.

This content playback information is provided from the information processing apparatus 100 to the application providing server 151, in a manner similar to that previously described with reference to the sequence diagram shown in FIG. 4.

The application providing server 151 provides a program-specific application list to the information processing apparatus.

The information processing apparatus 100 displays this list. Further, through processing similar to that described above with reference to FIGS. 9 and 10, the information processing apparatus 100 executes switching of display such as emphasized display configured to enable the user to recognize an optimal application corresponding to the segment being played back.

Through this processing, the user is able to readily select an optimal application corresponding to the content being currently viewed without hesitation.

### (4-3. Example of Provision of Applications in Playback of Various Kinds of Content)

While the above-described embodiment is directed to the example of acquisition/use of applications corresponding to a broadcast program, available applications or the like corresponding to not only a broadcast program but also, for example, a game program executed by using a game machine can be provided for use from the application providing server 151 to the information processing apparatus 100.

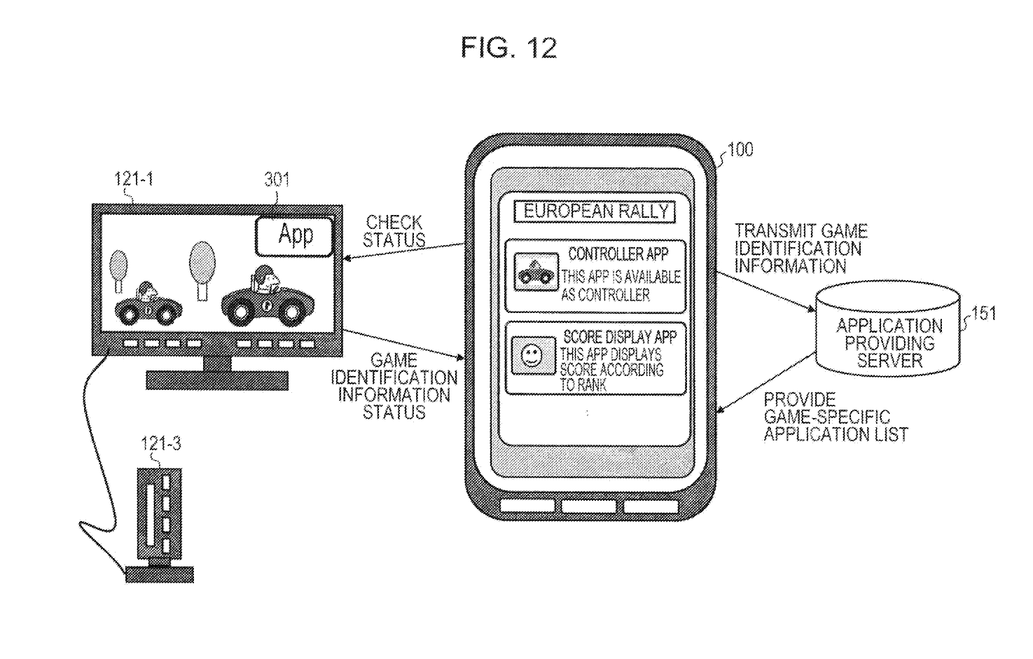

This processing example is described with reference to FIG. 12.

FIG. 12 shows a state in which the television 121-1 as a peripheral device is connected with a game machine 121-3 as another peripheral device, and a game is being executed in accordance with a game program in the game machine 121-3.

For example, the user receives and displays an application list for the game, which is provided to the information processing apparatus 100 from the application providing server 151. This processing is similar to the previously described with reference to FIG. 4.

In the processing described above with reference to FIG. 4, a list of program-related applications is acquired on the basis of program identification information. In the example shown in FIG. 12, the information processing apparatus 100 transmits a game identifier accepted from a peripheral device to the application providing server 151.

The application providing server 151 provides a list of applications related to the game in accordance with the game identifier, to the information processing apparatus.

The user can display the list on the information processing apparatus 100, select a desired application from the list, and acquire the application from the application providing server.

### (4-4. Installation of an Application to a Peripheral Device)

The above-described embodiment is mainly directed to the processing example in which recommendation information for an application is provided to an information processing apparatus such as a smartphone, and the application is installed to the information processing apparatus. However, a device to which an application is installed is not limited to an information processing apparatus such as a smartphone. For example, an application may be installed to a peripheral device such as a television or a game machine.

The installation of an application to such a peripheral device may be executed by direct communication between the peripheral device and the application providing server. Alternatively, an application acquired by an information processing apparatus such as a smartphone from a server may be output and installed to a peripheral device such as a television via the information processing apparatus such as a smartphone.

### 5. Example of the Hardware Configuration of Each of an Information Processing Apparatus and a Server

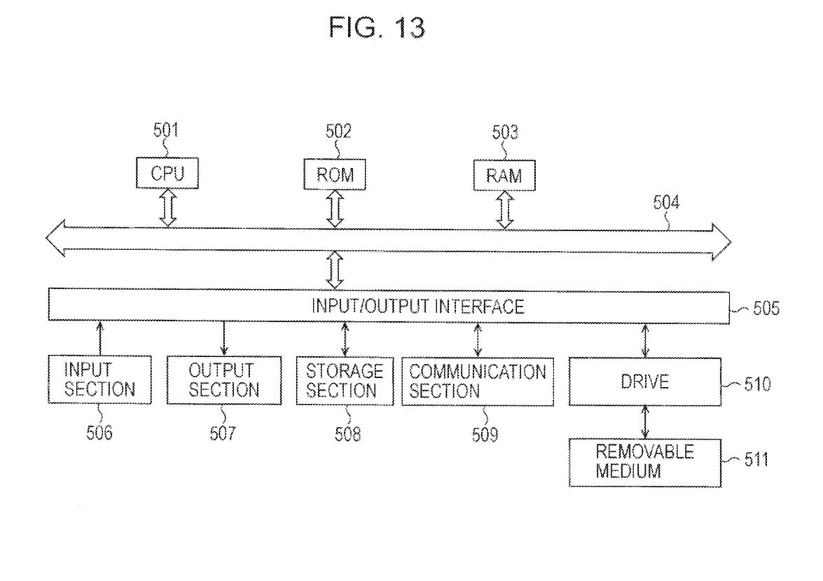

Lastly, an example of the hardware configuration of each of the information processing apparatus 100 and the application providing server 151 described in the above-mentioned embodiments is described with reference to FIG. 13.

The information processing apparatus 100 and the application providing server 151 described in the above-mentioned embodiments can each be implemented by an information processing apparatus such as a computer having a communication function. FIG. 13 is a diagram showing an example of such an information processing apparatus.

A central processing unit (CPU) 501 functions as a control section (data processing section) that executes various kinds of processing in accordance with a program stored in a read only memory (ROM) 502 or a storage section 508. For example, the CPU 501 executes processing such as acquisition and execution of applications described in each of the embodiments described above.

For example, a data processing section configured by the CPU 501 or the like transmits device information about each peripheral device of the information processing apparatus 100 or content information to a server, and displays a device-specific app list or a content-specific app list received from the server on a display section. In response to an input of user's app selection information with respect to the app list, the data processing section transmits the app selection information to the server, and acquires and executes an application program identified on the basis of the selection information from the server.

In a random access memory (RAM) 503, a program executed by the CPU 501, data, and the like are stored as appropriate. The CPU 501, the ROM 502, and the RAM 503 are connected to each other via a bus 504.

The CPU 501 is connected to an input/output interface 505 via the bus 504. The input/output interface 505 is connected with an input section 506 and an output section 507. The input section 506 is configured by a switch, keyboard, mouse, or microphone of various kinds, or the like. The output section 507 is configured by a display, a speaker, or the like. As a configuration integrating the input section 506 and the output section 507, for example, there is a touch panel type display section. The CPU 501 executes various kinds of processing in accordance with commands inputted from the input section 506, and outputs the processing results to, for example, the output section 507.

The storage section 508 connected to the input/output interface 505 is configured by, for example, a hard disk, a flash memory, or the like. The storage section 508 stores a program executed by the CPU 501 and various kinds of data. A communication section 509 communicates with an external apparatus via a network such as the Internet or a local area network.

A drive 510 connected to the input/output interface 505 drives a removal medium 511 such as a magnetic disk, an optical disc, a magneto-optical disc, or a semiconductor memory, and acquires various kinds of data such as recorded content and program.

The present disclosure has been described above in detail with reference to specific embodiments. However, it is obvious that a person skilled in the art can make various modifications to and substitutions for the embodiments without departing from the scope of the present disclosure. That is, the present disclosure has been disclosed by way of examples, and should not be construed restrictively. The scope of the present disclosure should be determined with reference to the appended claims.

The series of processes described in this specification can be executed by hardware, software, or a composite configuration of both. If the series of processes is to be executed by software, the series of processes can be executed by installing a program recording the processing sequence into a memory in a computer embedded in dedicated hardware, or by installing the program into a general purpose computer capable of executing various processes. For example, the program can be pre-recorded on a recording medium. Other than being installed into a computer from a recording medium, the program can be received via a network such as a local area network (LAN) or the Internet, and installed into a built-in recording medium such as a hard disk.

The various processes described in this specification may be executed not only time sequentially in the order as they appear in the description but may be executed in parallel or independently as necessary or depending on the throughput of the device executing the processes. Further, the term system as used in this specification refers to a logical aggregation of a plurality of devices, and is not limited to one in which the constituent devices are located within the same casing.

The present disclosure contains subject matter related to that disclosed in Japanese Priority Patent Application JP 2011-017889 filed in the Japan Patent Office on Jan. 31, 2011, the entire contents of which are hereby incorporated by reference.

What is claimed is:

1. An information processing apparatus comprising a data processing section, the data processing section being configured to:
transmit device information about a peripheral device of the information processing apparatus to a server;
display an app list on a display section, the app list being a list of device-specific application programs received from the server;
transmit app selection information to the server in response to an input of the app selection information by a user with respect to the app list; and
acquire and execute a device-specific application program identified on a basis of the app selection information from the server.

2. The information processing apparatus according to claim 1, wherein as the app list, the data processing section displays, on the display section, a list that associates a device name of the peripheral device with information about an available application corresponding to the peripheral device identified by the device name.

3. The information processing apparatus according to claim 1, further comprising a device discovery section that executes device discovery according to a Universal Plug and Play (UPnP) protocol,
wherein the data processing section transmits the device information about the peripheral device acquired by the device discovery section to the server.

4. The information processing apparatus according to claim 1, further comprising a QR code reader that executes reading of a QR code,
wherein the data processing section transmits the device information about the peripheral device acquired by the QR code reader to the server.

5. The information processing apparatus according to claim 1, wherein the data processing section transmits the device information about the peripheral device based on a user input made via an input section to the server.

6. An information processing apparatus comprising a data processing section, the data processing section being configured to:
transmit content identification information to a server;
display an app list on a display section, the app list being a list of content-specific application programs received from the server;
transmit app selection information to the server in response to an input of the app selection information by a user with respect to the app list; and
acquire and execute a content-specific application program identified on a basis of the app selection information from the server.

7. The information processing apparatus according to claim 6, wherein as the app list, the data processing section displays, on the display section, a list that associates a title of content with application information related to the content.

8. The information processing apparatus according to claim 6, wherein the app list displayed on the display section is a list of available applications linked to content played back by using a television or a recording/playback device as a peripheral device.

9. The information processing apparatus according to claim 6, wherein the data processing section outputs identification information indicating presence or absence of a content-specific application that can be acquired from the server within a content list displayed on the display section during execution of a remote control application corresponding to a television or a recording/playback device as a peripheral device.

10. An information processing method which is executed in an information processing apparatus, comprising a data processing section:
transmitting device information about a peripheral device of the information processing apparatus to a server;
displaying an app list on a display section, the app list being a list of device-specific application programs received from the server;
transmitting app selection information to the server in response to an input of the app selection information by a user with respect to the app list; and
acquiring and executing a device-specific application program identified on a basis of the app selection information from the server.

11. An information processing method which is executed in an information processing apparatus, comprising a data processing section:
transmitting content identification information to a server;
displaying an app list on a display section, the app list being a list of content-specific application programs received from the server;
transmitting app selection information to the server in response to an input of the app selection information by a user with respect to the app list; and
acquiring and executing a content-specific application program identified on a basis of the app selection information from the server.

12. A program for causing information processing to be executed in an information processing apparatus, the program comprising causing a data processing section to:
transmit device information about a peripheral device of the information processing apparatus to a server;
display an app list on a display section, the app list being a list of device-specific application programs received from the server;
transmit app selection information to the server in response to an input of the app selection information by a user with respect to the app list; and
acquire and execute a device-specific application program identified on a basis of the app selection information from the server.

13. A program for causing information processing to be executed in an information processing apparatus, the program comprising causing a data processing section to:
transmit content identification information to a server;
display an app list on a display section, the app list being a list of content-specific application programs received from the server;
transmit app selection information to the server in response to an input of the app selection information by a user with respect to the app list; and
acquire and execute a content-specific application program identified on a basis of the app selection information from the server.
